(19) United States
(12) Patent Application Publication
(10) Pub. No.: US 2026/0031336 A1
(43) Pub. Date: Jan. 29, 2026

(54) ACTIVE MATERIAL COMPOSITE PARTICLE AND BATTERY

(71) Applicant: DENSO CORPORATION, Kariya-city (JP)

(72) Inventors: Yuta MASUO, Kariya-city (JP); Yuta SHIMONISHI, Kariya-city (JP); Shuhei YOSHIDA, Kariya-city (JP)

(21) Appl. No.: 19/273,516

(22) Filed: Jul. 18, 2025

(30) Foreign Application Priority Data
Jul. 24, 2024 (JP) 2024-118522

(51) Int. Cl. H01M 4/36; H01M 4/02; H01M 4/505; H01M 4/525; H01M 4/58; H01M 4/62

(52) U.S. Cl. CPC H01M 4/366; H01M 4/505; H01M 4/525; H01M 4/5825; H01M 4/62; H01M 2004/021

(57) ABSTRACT

An active material composite particle includes an active material particle and a coating layer. The coating layer is in contact with at least a part of a surface of the active material particle. The coating layer includes a first component formed of an oxide-based ionic conductor having a crystalline phase, and a second component different from the first component. Particles constituting the first component are higher in particle strength than particles constituting the second component.

### CROSS REFERENCE TO RELATED APPLICATION

The present application claims the benefit of priority from Japanese Patent Application No. 2024-118522 filed on Jul. 24, 2024. The entire disclosure of the above application is incorporated herein by reference.

### TECHNICAL FIELD

The present disclosure relates to active material composite particles and batteries utilizing these particles.

### BACKGROUND

There is technique to form a coating layer containing lithium niobate (LiNbO₃) on the surface of active material particles made of oxide-based ceramic particles.

### SUMMARY

In the first aspect of the present disclosure, an active material composite particle is provided. The active material composite particle includes an active material particle, and a coating layer in contact with at least a part of a surface of the active material particle. The coating layer may include a first component formed of an oxide-based ionic conductor having a crystalline phase, and a second component different from the first component. Particles constituting the first component may be higher in particle strength than particles constituting the second component.

In the second aspect of the present disclosure, an active material composite particle is provided. The active material composite particle includes an active material particle, and a coating layer in contact with at least a part of a surface of the active material particle. The coating layer may include a first component formed of an oxide-based ionic conductor having a crystalline phase, and a second component different from the first component. The second component may have an amorphas phase, and a higher content of the amorphas phase than the first component.

### BRIEF DESCRIPTION OF THE DRAWINGS

FIG. 1 is a cross-sectional view showing the structure of a secondary battery according to an embodiment of the present disclosure.

FIG. 2 is a diagram showing specific examples of a positive electrode active material and a coating layer.

FIG. 3 is a diagram showing specific examples of the positive electrode active material and the coating layer.

FIG. 4 is a diagram showing specific examples of the positive electrode active material and the coating layer.

FIG. 5 is a diagram showing the crystal structure of a pyrochlore-type oxide.

FIG. 6 is a diagram showing the manufacturing process of a pyrochlore-type oxide.

FIG. 7 shows SEM images of the coating layers.

FIG. 8 shows a SEM image of an active material composite particle.

FIG. 9 shows SEM images of active material composite particles.

FIG. 10 shows SEM images of active material composite particles.

FIG. 11 shows the coverage rate, discharge characteristics, and durability characteristics of the active material composite particles of Working Examples and Comparative Examples.

### DESCRIPTION OF EMBODIMENTS

To begin with, examples of relevant techniques will be described.

There is technique to form a coating layer containing lithium niobate (LiNbO₃) on the surface of active material particles made of oxide-based ceramic particles. This suppresses the reaction between the active material particles and a sulfide-based solid electrolyte.

However, LiNbO₃ used in the coating layer has high ionic conduction resistance, necessitating the coating layer to be thin in order to reduce the resistance of the coating layer. In this case, the mechanical strength of the coating layer decreases, leading to its separation from the active material particles. Consequently, the coverage rate of the active material particles by the coating layer decreases, making it easier for the solid electrolyte and active material particles to come into contact.

In view of the above points, the present disclosure improves the coverage rate and durability of the coating layer in active material composite particles in which the active material particles are coated with a coating layer.

In the first and second aspects of the present disclosure, an active material composite particle includes an active material particle and a coating layer in contact with at least a part of a surface of the active material particle. The coating layer contains a first component formed of an oxide-based ionic conductor having a crystalline phase, and a second component different from the first component.

The crystalline first component contained in the coating layer functions as an anchor and filler. This improves the adhesion and contact of the coating layer to the active material particles, thereby enhancing the durability of the coating layer.

In the first aspect of the present disclosure, particles constituting the first component are higher in particle strength than particles constituting the second component. Thus, since the second component in the coating layer has lower strength than the first component, the second component is more easily deformable than the first component. Thus, the contact between the active material particles and the coating layer can be improved, and the coverage rate of the active material particles by the coating layer can be enhanced.

In the second aspect of the present disclosure, the second component has an amorphous phase, and a higher content of the amorphous phase than the first component. The second component with a higher content ratio of the amorphous phase is more easily deformable than the first component. Thus, the contact between the active material particles and the coating layer can be improved, and the coverage rate of the active material particles by the coating layer can be enhanced.

The embodiments of the present disclosure will be described below with reference to the drawings. In this embodiment, active material composite particles 140 are applied to a positive electrode active material of a secondary battery 10. The secondary battery 10 of this embodiment is a lithium-ion battery in which lithium ions conduct as conductive ions.

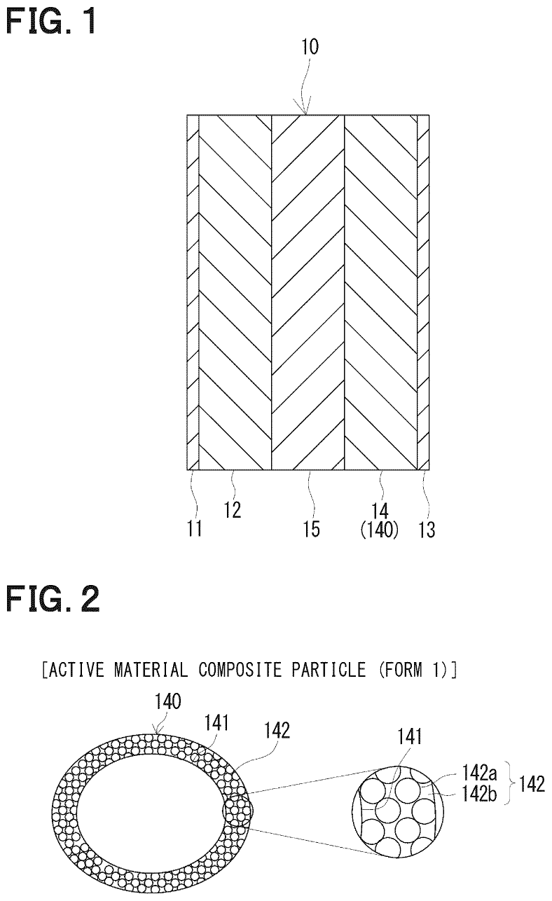

As shown in FIG. 1, the secondary battery 10 includes a negative electrode current collector 11, a negative electrode 12, a positive electrode current collector 13, a positive electrode 14, and an electrolyte layer 15.

The electrolyte layer 15 is sandwiched between the positive electrode 14 and the negative electrode 12. The negative electrode 12 and the electrolyte layer 15 are in contact with each other. The positive electrode 14 and the electrolyte layer 15 are in contact with each other. The negative electrode 12 and the positive electrode 14 are connected via the electrolyte layer 15. In the secondary battery 10 of this embodiment, charging and discharging are performed by lithium ions moving between the negative electrode 12 and the positive electrode 14 via the electrolyte layer 15.

The negative electrode current collector 11 and the positive electrode current collector 13 can be made of any material that can be used as a current collector for lithium-ion batteries. In this embodiment, Cu is used as the negative electrode current collector 11, and Al is used as the positive electrode current collector 13.

The negative electrode material constituting the negative electrode 12 can be any material that can be used as a negative electrode active material for lithium-ion batteries. The negative electrode material may be carbon-based negative electrode materials, oxide-based negative electrode materials, metal-based negative electrode materials.

The positive electrode 14 releases lithium ions during the charging of the secondary battery 10 and accepts lithium ions during the discharging of the secondary battery 10. The positive electrode 14 contains active material composite particles 140. The positive electrode 14 may include a conductive agent and a binder. Furthermore, the positive electrode 14 may contain an electrolyte or a polymer. The active material composite particles 140 will be described in detail later.

The electrolyte layer 15 has ion conductivity and can move lithium ions between the negative electrode 12 and the positive electrode 14. In this embodiment, a solid electrolyte is used as the electrolyte material for the electrolyte layer 15. Examples of the solid electrolyte include oxide-based solid electrolytes and sulfide-based solid electrolytes. The electrolyte layer 15 may include a binder. Furthermore, the electrolyte layer 15 may include an electrolyte solution or a polymer. The electrolyte solution may include ethylene carbonate. The electrolyte solution may be an ionic liquid. The polymer may be polyethylene oxide.

Next, the active material composite particles 140 of this embodiment will be described. FIGS. 2 to 4 show different forms of the coating layer 142 in the active material composite particle 140.

As shown in FIGS. 2 to 4, the active material composite particle 140 is a ceramic composite particle that includes an active material particle 141 and the coating layer 142 that covers the active material particle 141. The coating layer 142 is in contact with at least a part of the surface of the active material particle 141 and covers at least a part of the surface of the active material particle 141.

The active material particle 141 is a positive electrode active material. The active material particle 141 is a ceramic particle that undergoes redox reactions and releases or receives lithium ions, which are conductive ions, through the redox reactions.

The active material particle may be any material that can be used as a positive electrode active material for lithium-ion batteries. The active material particle may be layered rock-salt type active materials, olivine type active materials, or spinel type active materials. Examples of the layered rock-salt type active materials include ternary positive electrode materials such as LiNiₓCo_{y}Mn_{z}O₂ (i.e., NCM) and LiNiₓCo_{y}Al_{z}O₂ (i.e., NCA), where x+y+z=1. Examples of the olivine type active materials include LiFePO₄ (i.e., LFP), LiMn₁₋ₓFeₓPO₄ (i.e., LMFP), LiMnPO₄ (i.e., LMP), LiCoPO₄ (i.e., LCP), and LiNiPO₄ (i.e., LNP). Examples of the spinel type active materials include LiMn₂O₄ (i.e., LMO) and LiNi_{0.5}Mn_{1.5}O₄ (i.e., LNMO). Additionally, as the active material particles 141, Li_{1.3}Nb_{0.3}Mn_{0.4}O₂ containing Nb or Li₂MnO_{1.5}F_{1.5} containing F may be used.

The coating layer 142 is a composite having multiple components, including at least a first component 142a and a second component 142b. The first component 142a and the second component 142b are each particulate component. The first component 142a can be referred to as a first phase, and the second component 142b can be referred to as a second phase. The coating layer 142 contains at least one compound formed of an amorphous phase.

In this embodiment, the first component 142a is a crystalline oxide-based ionic conductor, and the second component 142b is an amorphous ionic conductor or an amorphous electronic conductor. The amorphous ionic conductor used as the second component 142b is a different type of ionic conductor from the crystalline ionic conductor used as the first component 142a.

The coating layer 142 may contain a third component that is different from the first component 142a and the second component 142b, and the coating layer 142 may include three or more components. When the coating layer 142 contains a third component, the first component 142a is a crystalline oxide-based ionic conductor, and one of the second component 142b and the third component is an amorphous ionic conductor while the other is an amorphous electronic conductor.

The oxide-based ionic conductor constituting the first component 142a may include at least a crystalline phase, and the oxide-based ionic conductor may be entirely crystalline or a mixture of amorphous and crystalline phases. The amorphous ionic conductor constituting the second component 142b may include at least an amorphous phase, and the amorphous ionic conductor may be entirely amorphous or a mixture of amorphous and crystalline phases. When the material constituting the second component 142b includes both an amorphous phase and a crystalline phase, it is desirable that the volume ratio of the amorphous phase is equal to or greater than the volume ratio of the crystalline phase. The second component 142b has a higher proportion of the amorphous phase compared to the first component 142a.

The crystalline first component 142a contained in the coating layer 142 exerts an anchoring effect on the active material particle 141. Furthermore, the first component 142a also serves as a filler. As a result, the adhesion and contact of the coating layer 142 to the active material particle 141 can be improved, enhancing the durability of the coating layer 142.

The amorphous second component 142b contained in the coating layer 142 is more deformable than the crystalline first component 142a. Thus, the contact between the active material particle 141 and the coating layer 142 can be improved, and the coverage rate of the active material particle 141 by the coating layer 142 can be enhanced.

As the crystalline oxide-based ionic conductor constituting the first component 142a, a pyrochlore-type oxide is preferably used. Examples of pyrochlore-type oxides include Li_{1.25}La_{0.58}Nb₂O₆F (i.e., LLNOF) and Li_{1.25}La_{0.58}Ta₂O₆F (i.e., LLTOF). The pyrochlore-type oxide in this embodiment has high ion conductivity. The pyrochlore-type oxide will be described in detail later.

As the amorphous ionic conductor used as the second component 142b, amorphous LiNbO₃ or amorphous LiF may be used. As the amorphous electronic conductor used as the second component 142b, amorphous carbon or non-crystallin carbon such as carbon black may be used.

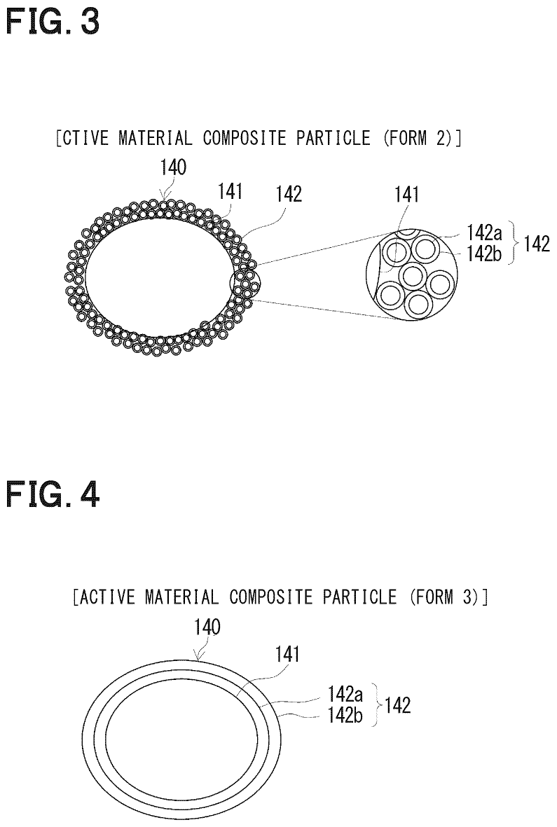

As shown in FIGS. 2, 3, and 4, the first component 142a and the second component 142b can be provided in various forms in the coating layer 142 of the active material composite particle 140. The first form in FIG. 2, the second form in FIG. 3, and the third form in FIG. 4 differ in the configuration of the first component 142a and the second component 142b within the coating layer 142 of the active material composite particle 140. Among the forms of the active material composite particle 140 shown in FIGS. 2, 3, and 4, the random structure shown in FIG. 2 is the most preferable form from the viewpoint of the high contact ratio between the second component 142b and the active material particle 141 as well as the first component 142a.

The coating layer 142 of the first form shown in FIG. 2 has a random structure in which the first component 142a and the second component 142b are randomly mixed. The coating layer 142 is exposed as the outer surface of the active material particle 141. In the first form, the outer surface of the active material particle 141 is in contact with the first component 142a and the second component 142b of the coating layer 142. In the first form, the random structure of the coating layer 142 is in contact with the entire outer surface of the active material particle 141, thereby covering the entire outer surface of the active material particle 141 with the coating layer 142. The first component 142a of the first form is particulate, and the first component 142a is surrounded by the second component 142b. The coating layer 142 with a random structure exists in a dispersed state where the particles constituting the first component 142a and the particles of the second component 142b are dispersed and mixed.

The coating layer 142 of the second form shown in FIG. 3 is formed of core-shell particles each having a core-shell structure in which the outer surface of the particulate first component 142a as a core is coated with the second component 142b as a shell. The core-shell particles stack on the active material particle 141. In the second form, the active material particle 141 is in contact with the second component 142b of the core-shell particles. Additionally, in the second form, the entire outer surface of the active material particle 141 is covered by the coating layer 142. In the second form, the particles constituting the first component 142a are separately coated by the second component 142b, forming core-shell particles. The core-shell structured coating layer 142 exists in a layered state where the first component 142a and the second component 142b overlap with each other.

The coating layer 142 in the third form shown in FIG. 4 has a layered structure in which the first component 142a and the second component 142b are formed in layers. In the third form, the outer surface of the active material particle 141 is coated with the first component 142a, and the outer surface of the first component 142a is coated with the second component 142b. FIG. 4 illustrates the third form as if the first component 142a and the second component 142b are separated and stacked in layers, but the second component 142b is actually present filling the gaps of the first component 142a.

The first component 142a is the main component of the coating layer 142. The volume ratio of the first component 142a in the coating layer 142 is equal to or greater than the volume ratio of components other than the first component 142a. That is, the volume ratio of the first component 142a in the coating layer 142 is 50% or more. In other words, the volume ratio of the first component 142a in the coating layer 142 is equal to or greater than the volume ratio of the second component 142b. If the coating layer 142 contains a third component, the volume ratio of the first component 142a in the coating layer 142 is equal to or greater than the combined volume ratio of the second component 142b and the third component. By increasing the volume ratio in the coating layer 142 of the first component 142a, which has high ionic conductivity, the ionic conductivity of the coating layer 142 can be increased.

In this embodiment, the particle strength of the active material particle 141 is higher than the particle strength of the first component 142a and the second component 142b in the coating layer 142. The particle strength of the crystalline first component 142a is generally higher than that of the amorphous second component 142b. Thus, the particle strengths of the active material particle 141, the first component 142a, and the second component 142b have the following relationship: the active material particle 141>the first component 142a>the second component 142b. The particle strengths of the active material particle 141, the first component 142a, and the second component 142b can be measured using the “Test method of fracture and deformation strength of a fine particle” as specified in JIS Z 8844. For example, the particle strength is measured with a strength evaluation tester (product name: MCT-510, manufactured by SHIMAZU CORPORATION) by compressing a target particle with a diameter of 1 μm with a compression element with a diameter of 50 μm.

For example, the particle strength of the active material particle 141 preferably falls within the range from 200 MPa to 250 MPa. The active material particle 141 having the above particle strength may be NCM (Nickel Cobalt Manganese). The particle strength of the first component 142a of the coating layer 142 preferably falls within the range from 130 MPa to 180 MPa. The first component 142a having the above particle strength may be LLNOF. The particle strength of the second component 142b of the coating layer 142 is preferably 50 MPa or less. For reference, the particle strength of LLZ, which is an oxide-based ionic conductor, is approximately 300 MPa.

When the particle strength of the active material particle 141 is greater than that of the first component 142a and the second component 142b of the coating layer 142, the coating layer 142 will preferentially break over the active material particle 141 when stress is applied to the active material composite particle 140. As a result, the breakage of the active material particle 141 can be suppressed when stress is applied to the active material composite particle 140.

Additionally, in the coating layer 142, the second component 142b, which has a lower particle strength than the first component 142a, is more easily deformed than the first component 142a, and can improve the contact between the active material particle 141 and the coating layer 142. As a result, the coverage rate of the active material particle 141 by the coating layer 142 can be improved.

It is desirable that the particle diameter of the first component 142a in the coating layer 142 is smaller than the particle diameter of the active material particle 141. By having the particle diameter of the first component 142a smaller than the particle diameter of the active material particle 141, the contact area between the first component 142a and the surface of the active material particle 141 can be increased, thereby improving the coverage rate of the active material particle 141 of the positive electrode 14 by the coating layer 142.

Additionally, it is desirable that the first component 142a of the coating layer 142 has a larger BET specific surface area than the active material particle 141. The BET specific surface area is the specific surface area calculated by the BET method, which measures the amount of gas physically adsorbed on the particle surface at low temperatures. By having the BET specific surface area of the first component 142a of the coating layer 142 larger than that of the active material particle 141, a similar effect can be obtained as when the particle diameter of the first component 142a is made smaller than the particle diameter of the active material particle 141. In other words, by having the BET specific surface area of the first component 142a of the coating layer 142 larger than that of the active material particle 141, the contact area between the first component 142a and the surface of the active material particle 141 can be increased, thereby improving the coverage rate of the active material particle 141 of the positive electrode 14 by the coating layer 142.

The coating layer 142 is in contact with at least a part of the surface of the active material particle 141. The coating layer 142 is in contact with the active material particle 141 and covers at least a part of the active material particle 141. By covering the surface of the active material particle 141, the coating layer 142 can suppress the active material particle 141 from coming into contact and reacting with other materials, such as the electrolyte in the electrolyte layer 15.

The coating layer 142 may cover the entire surface of the active material particle 141, or only a part of the surface of the active material particle 141. In order to suppress the active material particle 141 from coming into contact and reacting with the electrolyte layer 15, it is desirable that the coverage rate of the outer surface of the active material particle 141 by the coating layer 142 be as high as possible. In this embodiment, the coverage rate of the active material particle 141 by the coating layer 142 is set to 70% or more.

In the positive electrode 14, it is desirable to maximize the volume ratio of the active material particle 141 from the perspective of battery capacity. On the other hand, if the volume ratio of the coating layer 142 is reduced, the coverage rate of the active material particle 141 by the coating layer 142 will decrease. In this embodiment, the volume ratio of the coating layer 142 to the active material particle 141 falls within the range from 5% to 50%.

In order to increase the volume ratio of the active material particle 141, it is desirable that the coating layer 142 be as thin as possible. On the other hand, if the coating layer 142 is thin, the coverage rate of the active material particle 141 by the coating layer 142 will decrease. In this embodiment, the thickness of the coating layer 142 falls within the range from 1 to 100 nm.

It is desirable that at least one of the first component 142a or the second component 142b of the coating layer 142 is a compound containing the same element as the element contained in the active material particle 141. Examples of elements contained in the first component 142a or the second component 142b of the coating layer 142, which are the same elements as those contained in the active material particle 141, include Li and Nb.

When LLNOF or LLTOF is used as the first component 142a and LiNbO₃ is used as the second component 142b, Li is contained in both the first component 142a and the second component 142b of the coating layer 142. In this case, lithium-ion conductivity is improved since both the active material particle 141 and the coating layer 142 contain Li.

When LLNOF is used as the first component 142a and LiNbO₃ is used as the second component 142b, Nb is contained in both the first component 142a and the second component 142b of the coating layer 142. In this case, since both the active material particle 141 and the coating layer 142 contain the same element Nb, the adhesion and contact of the coating layer 142 to the active material particle 141 is improved through diffusion of the same element between the active material particle 141 and the coating layer 142.

Next, the pyrochlore-type oxide used as the first component 142a will be described. The pyrochlore-type oxide used in this embodiment has a pyrochlore structure represented by the composition formula “Aa_{2-α}Ab_{(1+α)/3}B₂O_{7-β}X_{γ}”. In the above composition formula, O represents an oxygen atom, and Aa, Ab, B, and X represent any elements or groups. Aa, Ab, and B are different types of cations, while O and X are different types of anions. Aa is an alkali metal cation. The pyrochlore-type oxide contains multiple cations in its composition, including an alkali metal cation Aa and multiple cations Ab and B that are different from the alkali metal cation Aa. In other words, the pyrochlore-type oxide contains multiple cations in its composition, including an alkali metal cation Aa.

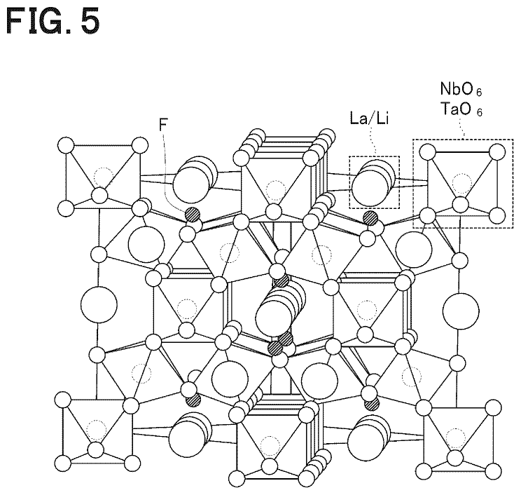

As shown in FIG. 5, the pyrochlore-type oxide has a crystal structure in which a three-dimensional network of octahedra formed of BO₆ (NbO₆, TaO₆) is formed. BO₆ consists of a cation B at the center with O positioned at the vertices of the octahedra, and shares vertices with adjacent BO₆. In the three-dimensional network consisting of BO₆, a hexagonal tunnel structure, where cation A and anion X are positioned, is formed.

In the above composition formula, 0.6<α<2.0, 0<β≤1, and 0<γ≤1. As α changes, the composition ratio of Aa to Ab changes, and as β and γ change, the composition ratio of O to X changes.

Cation Aa is an alkali metal cation. As the alkali metal represented by Aa, any one of Li, Na, K, Rb, or Cs can be used. As the cation Aa, Mg or H other than alkali metals may also be used. In other words, the cation Aa includes at least one selected from Li, Na, K, Rb, Cs, Mg, and H. In this embodiment, Li is used as Aa. The composition ratio (2−α) of Aa falls within the range of 0<(2−α)<1.4.

The cation Ab includes at least a lanthanoid. As the lanthanoid represented by Ab, at least one of La, Ce, Nd, or Sm can be used. In this embodiment, La is used as Ab. The composition ratio (1+α)/3 of Ab falls within the range of 0.53<(1+a)/3<1.

The basic structure of the cation Ab consists of a lanthanoid. However, a portion of the lanthanoid constituting Ab may be substituted with an alkaline earth metal (such as Ca, Mg, or Sr). The pyrochlore-type oxide of this embodiment has a composition where 0.6<α<2.0 and 0<β≤1 in the above formula. It is considered that the inclusion of a lanthanoid in the pyrochlore structure creates defects in the crystal structure, thereby improving ionic conductivity. In this embodiment, La is used as Ab.

The general pyrochlore structure has a composition formula “A₂B₂O₇”. In the pyrochlore-type oxide of this embodiment, the cation A in the above formula is a composite cation of a lithium metal and a lanthanoid. This is believed to contribute to the improvement of the ionic conductivity of the pyrochlore-type oxide.

The cation B is a metal cation different from Aa and Ab, selected from transition metals or metals from groups 13 to 15. B forms an octahedron surrounded by six O atoms within the crystal. As the transition metal represented by B, a group 4 or group 5 transition metal can be used, and more specifically, at least one of Nb, Ta, Ti, Zr, Hf, or V can be used. As the group 13 element represented by B, Al, Ga, or In can be used. As the group 14 element, Ge or Sn can be used. As the group 15 element, Sb or Bi can be used. In this embodiment, Nb or Ta is used as B.

The anion X is an anion that can substitute for the O atom constituting the pyrochlore structure. X has different electronegativity and polarizability compared to the O atom. As the anion represented by X, at least one of O, F, Cl, Br, I, S, OH, or P can be used. The composition ratio γ of X falls within the range of 0<γ≤1, and at least a part of the O atoms constituting the pyrochlore structure is substituted with X. In this embodiment, F is used as X.

The pyrochlore-type oxide of this embodiment has a defect structure in which the crystal includes lattice defects, by substituting a part of the O atoms constituting the pyrochlore structure with an anion that has different electronegativity and polarizability from the O atom. The pyrochlore-type oxide of this embodiment is believed to have improved ionic conductivity due to the defect structure within the pyrochlore structure.

In the pyrochlore-type oxide of this embodiment, a part of Aa and Ab is deficient as the defect structure. The general formula for a pyrochlore structure is “A₂B₂O₇”, and the compositional ratio of the cation A is 2. In contrast, in the pyrochlore-type oxide of this embodiment, the compositional ratios of Aa and Ab are “2−α” and “(1+α)/3” respectively. Since 0.6<α<2.0, the total compositional ratio of Aa and Ab is less than 2. In other words, in the crystal structure of the pyrochlore-type oxide of this embodiment, at least a part of either Aa or Ab is deficient. The compositional ratio corresponding to the deficient portions of Aa and Ab is (2α−1)/3.

Additionally, apart from the deviation in compositional ratios, a defect structure can also be formed by making the sum of the valences of the cations consisting of Aa, Ab, and B, and the anions consisting of O and X, negative in the above compositional formula.

Furthermore, the pyrochlore-type oxide of this embodiment is a complex anion compound that includes multiple anions such as O and X in its pyrochlore structure. Since the anion represented by X is present in the BO₆ coordinated octahedral structure, the alkali metal of Aa can be positioned in the central part of the space between the BO₆ coordinated octahedra, without being adjacent to the BO₆ coordinated octahedra. Thus, the pyrochlore-type oxide of this embodiment is considered to have high ionic conductivity when used under an electric field, such as in a battery.

Additionally, since α, β, and γ in the above compositional formula affect lattice defects and ionic conductivity, it is desirable to set α, β, and γ within an appropriate range. When the values of α, β, and γ are large, the defect concentration in the crystal lattice increases. However, if these values exceed a certain amount, the concentration of the alkali metal represented by Aa decreases, leading to a reduction in ionic conductivity. Thus, it is desirable to control a within the range of 0.6<α<2.0, within the range of 0<β≤1, and γ within the range of 0<γ≤1.

In this embodiment, a pyrochlore-type oxide represented by “Li_{1.25}La_{0.58}Nb₂O₆F (i.e., LLNOF)” or “Li_{1.25}La_{0.58}Ta₂O₆F (i.e., LLTOF)” is used as the pyrochlore-type oxide. In other words, Li is used as cation Aa, La as cation Ab, Nb or Ta as cation B, and F as anion X, with α set to 0.75, β set to 1, and γ set to 1.

The pyrochlore-type oxide of this embodiment achieves an ionic conductivity of 1×10⁻³ S/cm or higher. In the pyrochlore-type oxide of this embodiment, significantly higher ionic conductivity is achieved compared to other oxide-type solid electrolytes such as garnet-type oxides.

Next, the manufacturing method of the pyrochlore-type oxide in this embodiment will be explained. When using amorphous LiF as the second component 142b of the coating layer 142 in the active material composite particle 140, amorphous LiF can be simultaneously formed during the production of the pyrochlore-type oxide. For example, an amorphous phase of LiF as the second component 142b is formed on the surface of the pyrochlore-type oxide as the first component 142a by adding an excess amount of LiF, which is the raw material for producing the pyrochlore-type oxide, in the manufacturing process of the pyrochlore-type oxide.

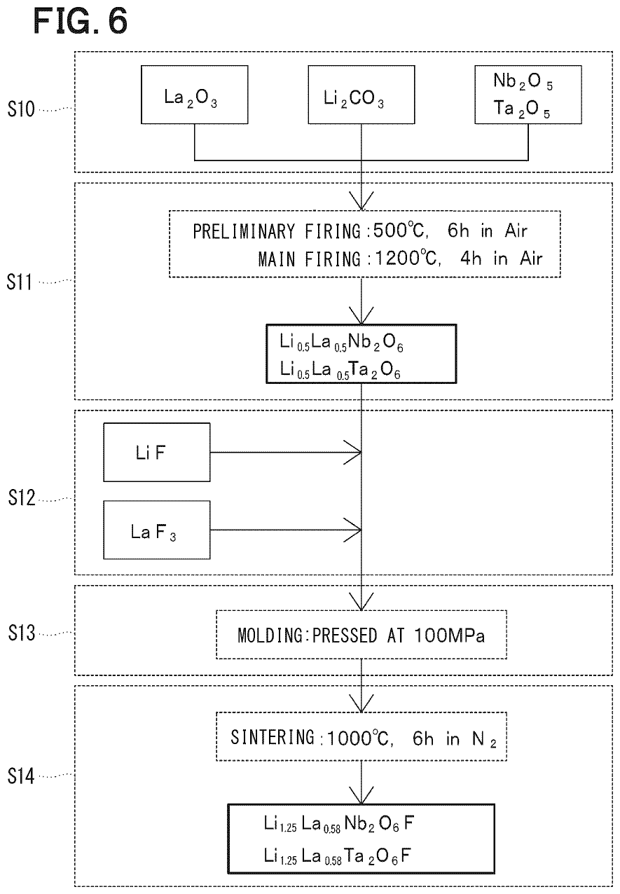

FIG. 6 illustrates the manufacturing method of the pyrochlore-type oxide according to this embodiment. In the manufacturing method of the pyrochlore-type oxide, the first mixing step S10, the first firing step S11, the second mixing step S12, the molding step S13, and the second firing step S14 are sequentially performed.

First, as raw materials for the pyrochlore-type oxide, a lanthanum source, a lithium source, and either a niobium source or a tantalum source are prepared, and these are mixed in the first mixing step S10. As the lanthanum source, lithium source, niobium source, and tantalum source, metal oxides or metal carbonates may be used. In this embodiment, La₂O₃ is used as the lanthanum source, Li₂CO₃ is used as the lithium source, Nb₂O₅ is used as the niobium source, and Ta₂O₅ is used as the tantalum source. In the first mixing step, La₂O₃, Li₂CO₃, and either Nb₂O₅ or Ta₂O₅ are mixed in a predetermined ratio.

Next, the first firing step S11 is performed in which the mixture prepared in the first mixing step is fired. In the first firing step S11, a two-stage firing process is performed. As the first stage, a preliminary firing is performed by heating the mixture in air at 500° C. for 6 hours. The preliminary firing removes moisture and other substances from the mixture, thereby enhancing its reactivity. Following the preliminary firing, the main firing is performed by heating the mixture in air at 1200° C. for 4 hours. As a result, either Li_{0.5}La_{0.5}Nb₂O₆ or Li_{0.5}La_{0.5}Ta₂O₆, which are precursors of the target substance, can be obtained.

Next, a fluorine source is prepared as a raw material, and this is mixed with the precursor in the second mixing step S12. A metal fluoride may be used as the fluorine source. In this embodiment, LiF and LaF₃ are used as the fluorine sources. LiF serves as both the fluorine source and the lithium source, while LaF₃ serves as both the fluorine source and the lanthanum source. In the second mixing step, LiF and LaF₃ are mixed with the precursor at a predetermined ratio. When using amorphous LiF as the second component 142b of the coating layer 142, an excess amount of LiF is added beyond the required amount for producing the pyrochlore-type oxide.

Next, the molding step S13 is performed in which the precursor and the mixed powder of LiF and LaF₃ are processed into pellets, and pressed at 100 MPa. As a result, the mixture of the precursor, LiF, and LaF₃ is formed into pellets.

Next, a second firing step S14 is performed in which the mixture of the precursor, LiF, and LaF₃ is sintered. In the second firing step S14, the mixture of the precursor, LiF, and LaF₃ is heated and sintered at 1000° C. for 6 hours in a nitrogen atmosphere. In the second firing step S14, to suppress compositional deviation due to the volatilization of Li and F elements, sintering may be performed in a sealed state or in a state covered with mother powder.

By cooling the product of the second firing step, a pyrochlore-type oxide represented by the compositional formula “Li_{1.25}La_{0.58}Nb₂O₆F (i.e., LLNOF)” or “Li_{1.25}La_{0.58}Ta₂O₆F (i.e., LLTOF)” is obtained. The resulting pyrochlore-type oxide is in particulate form. When LiF is excessively added in the second mixing step S12, the outer surface of the pyrochlore-type oxide is coated with LiF, resulting in particles with a core-shell structure having a pyrochlore-type oxide core phase and a LiF shell phase.

By controlling the cooling conditions after the second firing step, the amorphous phase of LiF can be increased. Specifically, by increasing the cooling rate of the product, the amorphization of LiF can be promoted, thereby increasing the volume ratio of the amorphous phase.

By changing the mixing ratio of La₂O₃, Li₂CO₃, Nb₂O₅ or Ta₂O₅, LiF, and LaF₃ in the above manufacturing process, it is possible to obtain a pyrochlore-type solid electrolyte represented by “Li_{2-α}La_{(1+α)/3}Nb₂O_{7-β}F_{γ}” or “Li_{2-α}La_{(1+α)/3}Ta₂O_{7-β}F_{γ}”. By changing the mixing ratio of La₂O₃, Li₂CO₃, Nb₂O₅ or Ta₂O₅, LiF, and LaF₃, the values of α, β, and γ in the composition formula can be adjusted. Additionally, a portion of the material sublimates during the firing process. Thus, the values of α, β, and γ can also be adjusted by changing the firing conditions, the atmosphere in the firing furnace, and the size of the firing furnace in the first and second firing processes.

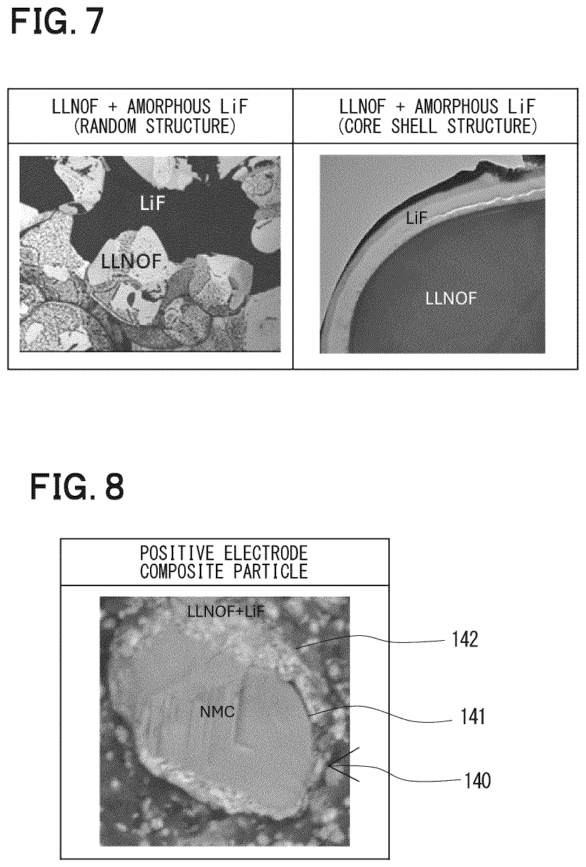

FIG. 7 shows SEM images of crystalline LLNOF, which is a pyrochlore-type oxide, and amorphous LiF. In FIG. 7, the left image shows a random structure where crystalline LLNOF and amorphous LiF are randomly mixed, while the right image shows a core-shell structure where crystalline LLNOF is covered by amorphous LiF. By the manufacturing method of this embodiment, a composite of crystalline LLNOF and amorphous LiF as shown in FIG. 7 is obtained.

Next, the manufacturing method of the active material composite particle 140 will be described. As a method for manufacturing the active material composite particle 140, techniques such as mechanochemical methods or rolling fluidization methods can be used.

First, the case where amorphous LiNbO₃ is used as the second component 142b of the coating layer 142 will be explained. When using amorphous LiNbO₃ as the second component 142b of the coating layer 142, a first coating step where crystalline LLNOF is coated onto the particulate active material particles 141 using a mechanochemical method, a second coating step where an LiNbO₃ precursor is coated onto the particles produced in the first coating step using a rolling fluidization method, and a heat treatment step to obtain amorphous LiNbO₃ from the precursor are performed in sequence.

In the first coating step, where crystalline LLNOF particles are coated onto the active material particles 141, the active material particles and pyrochlore-type oxide particles are mixed in a predetermined ratio (e.g., 90:10 to 99.1:0.1 wt %), and a high shear treatment is performed at 10,000 rpm for 5 minutes using a mechanochemical apparatus. For example, COMPOSI (product name, manufactured by NIPPON COKE & ENGINEERING Co., LTD.) may be used as the mechanochemical apparatus. The processing conditions may vary depending on the type of mechanochemical apparatus used. Through the first coating step, composite particles in which the active material particles 141 are coated with crystalline LLNOF particles are obtained.

When coating by the mechanochemical method, it is desirable that there is a significant size difference between the particle diameter of the coating particles constituting the coating layer 142 and the particle diameter of the active material particles 141 to be coated. Specifically, it is desirable that the coating particles have a particle diameter that is 1/10 or less of the particle diameter of the particles to be coated. In this embodiment, the particle diameter is defined as a volume-based particle size. The volume-based particle size may be measured using a laser diffraction/scattering particle size distribution analyzer (product name: Partica LA-950V2, manufactured by HORIBA, Ltd.).

Since the active material particles 141, which are the particles to be coated, generally range from 1 to 10 μm, the coating particles need to be no larger than 1 μm. However, when using coating particles of 1 μm, the thickness of the coating layer 142 increases, leading to an increase in resistance. Thus, in order to form the coating layer 142 that is 100 nm or less, it is more desirable for the coating particles to be 100 nm or less.

Following the first coating step, the second coating step is performed in which the LiNbO₃ precursor is coated onto the composite particles obtained from the first coating step by a rolling fluidization method. In the second coating step, an alkoxide solution is prepared by mixing and stirring ethoxylithium and pentaethoxyniobium in ethanol so that the elemental ratio of lithium to niobium becomes 1:1. Then, using a rolling fluidization apparatus, the alkoxide solution is sprayed to coat the active material particles obtained from the first coating step at a predetermined ratio in air at 80° C.

Subsequently, the heat treatment step is performed to obtain LiNbO₃ from the LiNbO₃ precursor. In the heat treatment step, the active material particles coated with the LiNbO₃ precursor are subjected to heat treatment at 300° C. for 2 hours in the atmosphere, resulting in the formation of LiNbO₃ containing an amorphous phase.

Next, the case where amorphous carbon particles (amorphous carbon) are used as the second component 142b of the coating layer 142 will be described. In this case, a first coating step in which the particulate active material particles 141 are coated with crystalline LLNOF using a mechanochemical method, and a second coating step in which the particles produced in the first coating step are coated with carbon particles, which are the second component 142b, using a mechanochemical method, are carried out sequentially. The first coating step may be carried out using the same procedure as when amorphous LiNbO₃ is used as the second component 142b.

Following the first coating step, the second coating step is performed in which carbon particles are coated using a mechanochemical method. In the second coating step, the composite particles obtained in the first coating step and the carbon particles are mixed in a predetermined ratio and subjected to a high shear treatment at 5000 rpm for 3 minutes using a mechanochemical device. The processing conditions may vary depending on the type of mechanochemical apparatus used.

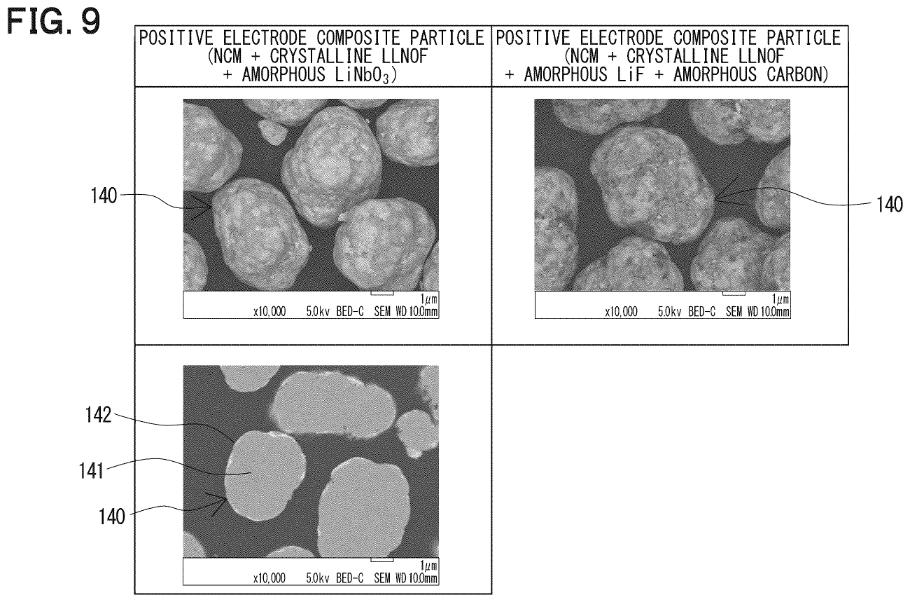

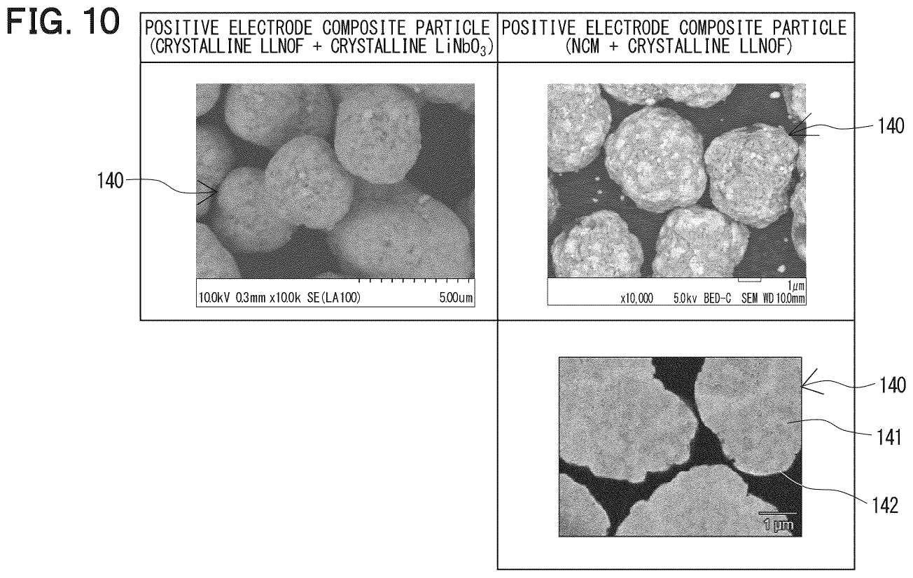

FIGS. 8, 9, and 10 show SEM images of the active material composite particles 140. FIGS. 8 and 9 show SEM images of the active material composite particles 140 of the present embodiment. FIG. 10 shows a SEM image of the active material composite particles 140 of the comparative example. FIG. 8 shows a cross-section of the active material composite particle 140. FIGS. 9 and 10 show the external appearance of the active material composite particles 140 in the upper section, and a cross-section of the active material composite particles 140 in the lower section.

The active material composite particles 140 in FIG. 8 use NCM as the active material particles 141, crystalline LLNOF as the first component 142a of the coating layer 142, and amorphous LiF as the second component 142b of the coating layer 142. The coating layer 142 has a random structure in which the first component 142a and the second component 142b are randomly mixed. The structure of the active material composite particles 140 in FIG. 8 corresponds to Working Example 4 described later.

The active material composite particles 140 shown on the left side of FIG. 9 use NCM as the active material particles 141, crystalline LLNOF as the first component 142a of the coating layer 142, and amorphous LiNbO₃ as the second component 142b of the coating layer 142. The structure of the active material composite particles 140 shown on the left side of FIG. 9 corresponds to Working Example 1 described later.

The active material composite particles 140 shown on the right side of FIG. 9 use NCM as the active material particles 141, crystalline LLNOF as the first component 142a of the coating layer 142, amorphous LiF as the second component 142b, and amorphous carbon as the third component. The structure of the active material composite particles 140 shown on the right side of FIG. 9 corresponds to Working Example 8 described later.

The active material composite particles 140 shown on the left side of FIG. 10 use NCM as the active material particles 141 and amorphous LiNbO₃ as the second component 142b of the coating layer 142. The structure of the active material composite particles 140 shown on the left side of FIG. 10 corresponds to Comparative Example 1 described later.

The active material composite particles 140 shown on the right side of FIG. 10 use NCM as the active material particles 141 and crystalline LLNOF as the first component 142a of the coating layer 142. The structure of the active material composite particles 140 shown on the right side of FIG. 10 corresponds to Comparative Example 2 described later.

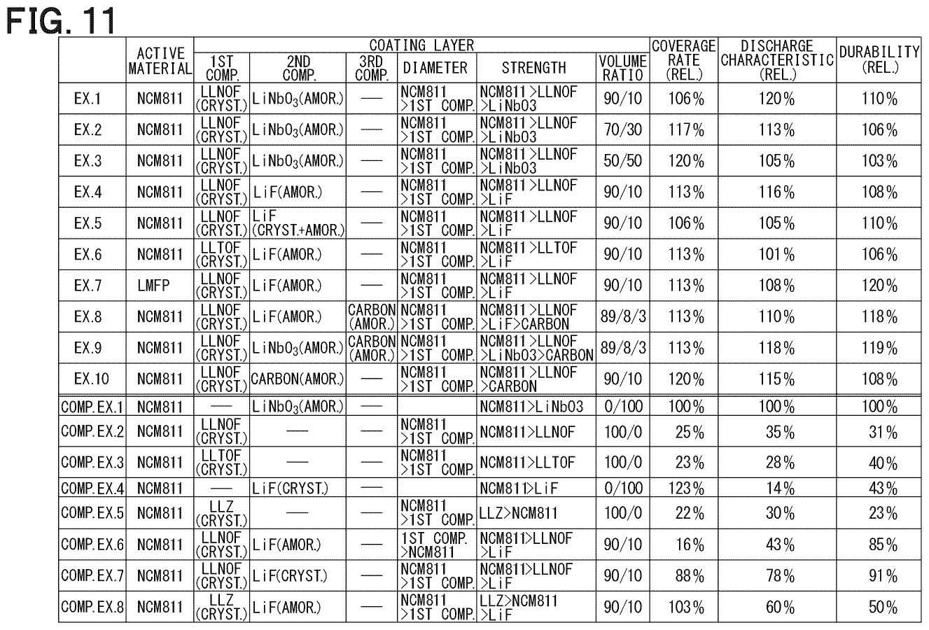

Next, the coverage rate of the active material composite particles 140, as well as the discharge characteristics and durability characteristics of the secondary battery 10 using the active material composite particles 140, will be explained using working examples and comparative examples shown in FIG. 11.

Working Examples 1 to 10 and Comparative Examples 1 to 8 are different from each other in the type of active material particles 141 or the type of coating layer 142. The coverage rate in FIG. 11 is the proportion of the total surface area of the active material particles 141 that is covered by the coating layer 142. The discharge characteristic in FIG. 11 is the dischargeable time required for the voltage to reach the lower limit when the secondary battery 10 is discharged at 5 C. The durability characteristic in FIG. 11 indicates the battery capacity retention rate of the secondary battery 10 after performing a cycle charge-discharge test at 60° C. and 0.5 C. In FIG. 11, the coverage rate, discharge characteristic, and durability characteristic are displayed as relative values when the value of Comparative Example 1 is set to 100%.

Working Examples 1 to 6, 8 to 10, and Comparative Examples 1 to 8 use LiNi_{0.8}Co_{0.1}Mn_{0.1}O₂ (i.e., NCM811) as the active material particles 141. Working Example 7 uses LiMn_{0.6}Fe_{0.4}PO₄ (i.e., LMFP) as the active material particles 141.

Working Examples 1 to 10, Comparative Examples 2 to 3, and 5 to 8 use a crystalline ionic conductor as the first component 142a of the coating layer 142. In Comparative Examples 1 and 4, the first component 142a of the coating layer 142 is not provided.

Working Examples 1 to 5, 7 to 10, and Comparative Examples 2, 6, and 7 use crystalline LLNOF as the first component 142a of the coating layer 142. In Working Example 6 and Comparative Example 3, crystalline LLTOF is used as the first component 142a of the coating layer 142. In Comparative Examples 5 and 8, crystalline LLZ is used as the first component 142a of the coating layer 142.

In Working Examples 1 to 9 and Comparative Examples 1, 6, and 8, an amorphous ionic conductor is used as the second component 142b of the coating layer 142. In Working Example 10, an amorphous electronic conductor is used as the second component 142b of the coating layer 142. In Comparative Examples 4 and 7, a crystalline ionic conductor is used as the second component 142b of the coating layer 142. In Comparative Examples 2, 3, and 5, the second component 142b of the coating layer 142 is not provided.

In Working Examples 1 to 3 and 9, amorphous LiNbO₃ is used as the second component 142b of the coating layer 142. In Working Example 4, amorphous LiF is used as the second component 142b of the coating layer 142. In Working Example 5, LiF containing both crystalline and amorphous phases is used as the second component 142b of the coating layer 142. In Working Example 10, amorphous carbon is used as the second component 142b of the coating layer 142.

In Working Examples 8 and 9, the coating layer 142 contains a third component. In Working Examples 8 and 9, amorphous carbon is used as the third component of the coating layer 142.

In Working Examples 1, 4 to 7, and 10, the volume ratio of the first component 142a to the second component 142b of the coating layer 142 is 90:10. In Working Example 2, the volume ratio of the first component 142a to the second component 142b of the coating layer 142 is 70:30. In Working Example 3, the volume ratio of the first component 142a to the second component 142b of the coating layer 142 is 50:50. In Working Examples 8 and 9, the volume ratio of the first component 142a, the second component 142b, and the third component of the coating layer 142 is 89:8:3.

In Comparative Examples 1 and 4, the volume ratio of the first component 142a to the second component 142b of the coating layer 142 is 0:100. In Comparative Examples 2, 3, and 5, the volume ratio of the first component 142a to the second component 142b of the coating layer 142 is 100:0. In Comparative Examples 6 to 8, the volume ratio of the first component 142a to the second component 142b of the coating layer 142 is 90:10.

In Working Examples 1 to 10 and Comparative Examples 2, 3, and 5 to 8, which have the first component 142a of the coating layer 142, the particle diameter of the active material particles 141 exceeds the particle diameter of the first component 142a of the coating layer 142.

In Working Examples 1 to 10 and Comparative Examples 6 and 7, the particle strength has the relationship of the active material particles 141>the first component 142a>the second component 142b. In Comparative Examples 1 and 4, the particle strength has the relationship of the active material particles 141>the second component 142b. In Comparative Examples 2 and 3, the particle strength has the relationship of the active material particles 141>the first component 142a. In Comparative Example 5, the particle strength has the relationship of the first component 142a>the active material particles 141. In Comparative Example 8, the particle strength has the relationship of the first component 142a>the active material particles 141>the second component 142b. The particle strength was measured with a strength evaluation tester (product name: MCT-510, manufactured by SHIMAZU CORPORATION) by compressing a target particle with a diameter of 1 μm using a compression element with a diameter of 50 μm.

As shown in FIG. 11, in Working Examples 1 to 10, the coverage rate, discharge characteristics, and durability characteristics all exceed 100%. In contrast, in Comparative Examples 2, 3, and 4 to 8, the coverage rate, discharge characteristics, and durability characteristics all fall below 100%. In Comparative Examples 4 and 8, although the coverage rate exceeds 100%, the discharge characteristics and durability characteristics fall below 100%.

In Working Examples 1 to 10, it is considered that the high coverage rate was achieved because the coating layer 142 contains the second component 142b which has a lower particle strength than the first component 142a and a higher content of amorphous phase than the first component 142a.

Additionally, in Working Examples 1 to 10, it is considered that the high discharge characteristics were achieved because the coating layer 142 contains the first component 142a, which is an ionic conductor, and the second component 142b, which is at least one of an ionic conductor and an electronic conductor.

Additionally, in Working Examples 1 to 10, it is considered that the high durability characteristics were achieved because the crystalline first component 142a contained in the coating layer 142 functions as an anchor and filler.

According to the present embodiment described above, the durability and coverage rate of the coating layer 142 can be improved since the active material composite particle includes the crystalline first component 142a and the second component 142b, which has lower particle strength than the first component 142a or is amorphous, in the coating layer 142. The delamination of the coating layer 142 from the active material particles 141 tends to occur during the kneading process when creating electrodes and during the expansion and contraction of the secondary battery 10 due to charge and discharge cycles. In contrast, by using the active material composite particles 140 of the present embodiment, the coating layer 142 can effectively suppress the active material particles 141 from reacting with other materials.

Since the crystalline ionic conductor as the first component 142a is included in the coating layer 142, the first component 142a functions as an anchor and filler. As a result, the adhesion and contact of the coating layer 142 to the active material particle 141 can be improved, enhancing the durability of the coating layer 142. Furthermore, by using a material with high ionic conductivity as the first component 142a, the ionic conductivity of the coating layer 142 can be improved, thereby enhancing the discharge characteristics.

Additionally, the coating layer 142 includes the second component 142b which has lower particle strength than the first component 142a and is more deformable than the first component 142a. Thus, the contact between the active material particle 141 and the coating layer 142 can be improved, and the coverage rate of the active material particle 141 by the coating layer 142 can be enhanced.

Additionally, the coating layer 142 includes the second component 142b which is amorphous, and the amorphous second component 142b is more deformable than the crystalline first component 142a. Thus, the contact between the active material particle 141 and the coating layer 142 can be improved, and the coverage rate of the active material particle 141 by the coating layer 142 can be enhanced.

In other words, the coating layer 142 contains the crystalline first component 142a and the second component 142b that is different from the first component. The second component 142b has lower particle strength than the first component 142a or is amorphous. This allows for the improvement of both the durability and the coverage rate of the coating layer 142.

Additionally, in this embodiment, the particle strength of the active material particles 141 is higher than the particle strength of both the first component 142a and the second component 142b of the coating layer 142. As a result, when stress is applied to the active material composite particles 140, the coating layer 142 will preferentially break before the active material particles 141, thereby preventing the active material particles 141 from being damaged.

Additionally, in this embodiment, the coating layer 142 contains a compound with an amorphous phase component that has ion conductivity (such as LiNbO₃ or LiF) as the second component 142b. Thus, the ionic conductivity of the coating layer 142 is improved, thereby improving the lithium-ion conductivity of the positive electrode 14.

Additionally, according to this embodiment, the coating layer 142 contains a compound that includes the same element as an element contained in the active material particles 141. For example, when the coating layer 142 contains a compound that includes Li, which is the same element contained in the active material particles 141, the lithium-ion conductivity of the coating layer 142 can be improved. When the coating layer 142 contains a compound that includes Nb, which is the same element contained in the active material particles 141, the diffusion of the same element between the coating layer 142 and the active material particles 141 can improve the adhesion and contact of the coating layer 142 to the active material particles 141.

Additionally, according to this embodiment, by using a pyrochlore-type oxide as the crystalline ionic conductor constituting the first component 142a of the coating layer 142, the ionic conductivity of the coating layer 142 can be improved.

Additionally, according to this embodiment, the particle diameter of the first component 142a of the coating layer 142 is made smaller than the particle diameter of the active material particles 141. As a result, the contact area between the first component 142a and the particle surface of the active material particles 141 can be increased, thereby improving the coverage rate of the active material particle 141 of the positive electrode 14 by the coating layer 142.

Additionally, according to this embodiment, the BET specific surface area of the first component 142a of the coating layer 142 is made larger than that of the active material particles 141. This also increases the contact area between the first component 142a and the particle surface of the active material particles 141, thereby improving the coverage rate of the active material particle 141 by the coating layer 142.

Additionally, according to this embodiment, the volume ratio of the first component 142a in the coating layer 142 is greater than or equal to the volume ratio of the other components. By increasing the volume ratio in the coating layer 142 of the first component 142a, which has high ionic conductivity, the ionic conductivity of the coating layer 142 can be increased.

Additionally, in this embodiment, the active material composite particles 140 are applied to the secondary battery 10. The active material particles are prone to deteriorate during the charging of the secondary battery 10. Thus, by using the active material composite particles 140 of this embodiment in the secondary battery 10, the deterioration of the active material particles 141 during charging can be effectively suppressed.

Additionally, when a sulfide-based solid electrolyte is used as the electrolyte layer 15, the active material particles 141 are more prone to deteriorate. Thus, in a secondary battery 10 that uses a sulfide-based solid electrolyte as the electrolyte layer 15, employing the active material composite particles 140 of this embodiment can effectively suppress the deterioration of the active material particles 141.

(Other embodiments) The present disclosure is not limited to the above-described embodiments and can be variously modified as follows without departing from the spirit of the disclosure. Additionally, the means disclosed in each of the above embodiments can be appropriately combined within the scope of feasibility.

For example, in the above embodiments, the application of the active material composite particles of the present disclosure to the active material of secondary batteries has been described. However, the active material composite particles of the present disclosure may be applied to the active material of primary batteries.

Additionally, in the above embodiments, the application of the active material composite particles of the present disclosure to lithium-ion batteries, where the conductive ions are lithium ions, has been described. However, the active material composite particles of the present disclosure may be applied to secondary batteries with different conductive ions. Specifically, the active material composite particles of the present disclosure may be applied to potassium-ion batteries where potassium ions conduct, or sodium-ion batteries where sodium ions conduct.

Additionally, in the above embodiments, the application of the active material composite particles 140 of the present disclosure to the positive electrode 14, and the active material particles 141 of the active material composite particles 140 used as positive electrode active material particles, have been described. However, the active material composite particles of the present disclosure may also be applied to the negative electrode 12, and negative electrode active material may be as the active material particles of the active material composite particles.

Additionally, in the above embodiments, the application of the active material composite particles of the present disclosure to a secondary battery 10 with a pre-installed negative electrode 12 has been described. However, the active material composite particles of the present disclosure may also be applied to an anode-free battery. In an anode-free battery, the negative electrode 12 is not formed on the negative electrode current collector 11 in the initial state. Instead, during charging, lithium metal is deposited on the negative electrode current collector 11 by lithium ions that move from the positive electrode 14, thereby forming the negative electrode 12. Then, the lithium metal constituting the negative electrode 12 moves to the positive electrode 14 as lithium ions during discharge.

Additionally, in the above embodiments, the application of the active material composite particles 140 of the present disclosure to an all-solid-state battery using a solid electrolyte as the electrolyte layer 15 has been described. However, the active material composite particles 140 of the present disclosure may also be applied to different types of secondary batteries.

For example, the active material composite particles 140 of the present disclosure may be applied to a liquid-type secondary battery provided with an electrolyte solution and a separator. As the electrolyte solution, for example, ethylene carbonate or ionic liquids can be used. As the separator, for example, a porous body can be used.

Additionally, the active material composite particles 140 of the present disclosure may be applied to semi-solid batteries. Examples of semi-solid batteries include a gel polymer type using a gelled electrolyte, a clay type in which the electrolyte is kneaded into a clay substance, and a liquid addition type in which a small amount of electrolyte solution is impregnated into the electrode material.

Additionally, the active material composite particles 140 of the present disclosure may be applied to bipolar batteries. A bipolar battery has a structure in which multiple battery cells are stacked and connected in series, and the current collectors are shared between adjacent battery cells. In other words, the current collector in contact with the positive electrode of one adjacent battery cell is in contact with the negative electrode of the other adjacent battery cell.

1. An active material composite particle comprising:
an active material particle; and
a coating layer in contact with at least a part of a surface of the active material particle, wherein
the coating layer includes:
a first component formed of an oxide-based ionic conductor having a crystalline phase; and
a second component formed of a different component from the first component, and
particles constituting the first component are higher in particle strength than particles constituting the second component.

2. An active material composite particle comprising:
an active material particle; and
a coating layer in contact with at least a part of a surface of the active material particle, wherein
the coating layer includes:
a first component formed of an oxide-based ionic conductor having a crystalline phase; and
a second component formed of a different component from the first component, and
the second component has an amorphas phase, and a higher content of the amorphas phase than the first component.

3. The active material composite particle according to claim 2, wherein
particles constituting the first component is higher in particle strength than particles constituting the second component.

4. The active material composite particle according to claim 1, wherein
the active material particle has higher particle strength than the particles constituting the first component.

5. The active material composite particle according to claim 1, wherein
the second component is an ionic conductor or an electronic conductor.

6. The active material composite particle according to claim 1, wherein
the first component and the second component are arranged in a layer state or a dispersion state within the coating layer.

7. The active material composite particle according to claim 1, wherein
the coating layer includes a compound containing a same element with an element contained in the active material particle.

8. The active material composite particle according to claim 1, wherein
the oxide-based ionic conductor is a pyrochlore oxide.

9. The active material composite particle according to claim 8, wherein
the pyrochlore oxide includes a defect structure and has a composition formula expressed by Aa_{2-α}Ab_{(1+α)/3}B₂O_{7-β}X_{γ}, where:
Aa is an alkali metal,
Ab includes a lanthanoid,
B is a cation different from Aa and Ab,
X is an anion replaceable by an O atom that forms the pyrochlore oxide,
0.6<α<2.0,
0<β≤1, and
0<γ≤1.

10. The active material composite particle according to claim 1, wherein
the particles constituting the first component have a smaller particle diameter than the active material particle.

11. The active material composite particle according to claim 1, wherein
the particles constituting the first component have a higher BET specific surface area than the active material particle.

12. The active material composite particle according to claim 1,
a volume ratio of the first component in the coating layer is equal to or greater than a volume ratio of components other than the first component in the coating layer.

13. The active material composite particle according to claim 1, wherein
the particle strength of the particles constituting the first component falls within a range from 130 MPa to 180 MPa, and
the particle strength of the particle constituting the second component is equal to or less than 50 MPa.

14. A battery comprising:
a positive electrode having a positive electrode active material; and
a negative electrode having a negative electrode active material, and
the active material composite particle according to claim 1 is used as the positive electrode active material or the negative electrode active material.

15. The active material composite particle according to claim 1, wherein
the second component of the coating layer is at least one of LiNbO₃ including an amorphas phase, LiF including an amorphas phase, or carbon including an amorphas phase.

16. The active material composite particle according to claim 15, wherein
the coating layer further includes a third component, and
the third component is carbon including an amorphas phase.

17. The active material composite particle according to claim 16, wherein
the active material particle includes at least one of LiNiₓCo_{y}Mn_{z}O₂ (NCM), where x+y+z=1, or LiMn₁₋ₓFeₓPO₄ (LFMP).

18. A method for producing an active material composite particle comprising:
mixing an active material particle with a first component that is formed of an oxide-based ionic conductor having a crystalline phase to form a first composite particle in which the active material particle is coated with the first component; and
coating the first composite particle with a second component that is formed of a different component from the first component, wherein
particles constituting the first component are higher in particle strength than particles constituting the second component.

19. The method according to claim 18, wherein
coating the first composite particle with the second component includes:
coating the first composite particle with a precursor of the second component to form a second composite particle; and
heating the second composite particle to convert the precursor to the second component.

20. The method according to claim 18, wherein
the active material composite particle is used as a positive electrode composite particle.
